(19) United States
(12) Patent Application Publication
(10) Pub. No.: US 2016/0277494 A1
(43) Pub. Date: Sep. 22, 2016

(54) SYNCHRONIZATION CONTROL DEVICE, SYNCHRONIZATION SYSTEM, AND SYNCHRONIZATION CONTROL METHOD

(71) Applicant: Kabushiki Kaisha Toshiba, Minato-ku (JP)

(72) Inventor: Masashi ITO, Yokohama (JP)

(73) Assignee: Kabushiki Kaisha Toshiba, Minato-ku (JP)

(21) Appl. No.: 14/878,038

(22) Filed: Oct. 8, 2015

(30) Foreign Application Priority Data
Mar. 16, 2015 (JP) 2015-052223

(51) Int. Cl. H04L 29/08

(52) U.S. Cl. CPC H04L 67/1095

(57) ABSTRACT

According to an embodiment, a synchronization control device is connectable to a server via a network. The device includes an acquisition unit and a determination unit. The acquisition unit acquires one or more condition values relating to one or more conditions for determining at least one of a certain communication mode and a certain synchronization mode. The certain communication mode is a mode for communicating with the server and is used in time synchronization for synchronizing time between the synchronization control device and the server. The certain synchronization mode is a mode for synchronizing time of the synchronization control device with reference time measured by the server and is used in the time synchronization. The determination unit determines, by using the condition values, at least one of the certain communication mode out of a plurality of communication modes and the certain synchronization mode out of a plurality of synchronization modes.

### CROSS-REFERENCE TO RELATED APPLICATIONS

This application is based upon and claims the benefit of priority from Japanese Patent Application No. 2015-052223, filed on Mar. 16, 2015; the entire contents of which are incorporated herein by reference.

### FIELD

Embodiments described herein relate generally to a synchronization control device, a synchronization system, and a synchronization control method.

### BACKGROUND

Technologies are known in which a device acquires reference time measured external to the device and synchronizes the internal time managed in the device with the reference time.

The time synchronized with the reference time is used for various purposes. Thus, the synchronization with the reference time is in general performed in accordance with a method suitable for the usage of the time. However, in such a conventional technology above, the synchronization with the reference time can be performed only by using a fixed and predetermined synchronization method, thereby limiting the usage of the time.

### BRIEF DESCRIPTION OF THE DRAWINGS

FIG. 1 is a diagram illustrating an example of a synchronization system according to a first embodiment;

FIG. 2 is a diagram illustrating an example of a synchronization device according to the first embodiment;

FIG. 3 is a diagram illustrating an example of one or more condition values according to the first embodiment;

FIG. 4 is a diagram illustrating an example of a determination table according to the first embodiment;

FIG. 5 is a diagram illustrating an example of a configuration of a server according to the first embodiment;

FIG. 6 is a flowchart illustrating an example of the process procedure performed by the synchronization device according to the first embodiment;

FIG. 7 is a flowchart illustrating an example of the process procedure performed at Step S103 in FIG. 6;

FIG. 8 is a flowchart illustrating an example of the process procedure performed by the server according to the first embodiment;

FIG. 9 is a diagram illustrating an example of a synchronization device according to a second embodiment;

FIG. 10 is a diagram illustrating an example of a synchronization system according to third embodiment;

FIG. 11 is a diagram illustrating an example of a synchronization device according to the third embodiment; and

FIG. 12 is a diagram illustrating an example of a hardware configuration of the synchronization devices according to the first to the third embodiments.

### DETAILED DESCRIPTION

According to an embodiment, a synchronization control device is connectable to a server via a network. The device includes an acquisition unit and a determination unit. The acquisition unit acquires one or more condition values relating to one or more conditions for determining at least one of a certain communication mode and a certain synchronization mode. The certain communication mode is mode for communicating with the server and is used in time synchronization for synchronizing time between the synchronization control device and the server. The certain synchronization mode is a mode for synchronizing time of the synchronization control device with reference time measured by the server and is used in the time synchronization. The determination unit determines, by using the one or more condition values, at least one of the certain communication mode out of a plurality of communication modes and the certain synchronization mode out of a plurality of synchronization modes.

The following describes detailed embodiments with reference to the accompanying drawings.

### First Embodiment

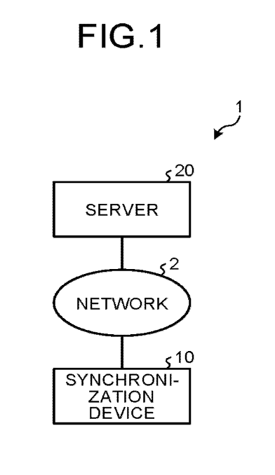

FIG. 1 is a diagram illustrating an example of a configuration of a synchronization system 1 according to a first embodiment. As illustrated in FIG. 1, the synchronization system 1 includes a synchronization device 10 (an example of a synchronization control device) and a server 20. The synchronization device 10 and the server 20 are connected to each other via a network 2. Examples of the network 2 include a local area network (LAN), a wide area network (WAN), a dedicated line, and the Internet. The network 2 may be a wired network or a wireless network.

The server 20 is a computer that measures reference time for time synchronization. The synchronization device 10 uses the reference time measured by the server 20 to synchronize the internal time of the synchronization device 10 with the reference time. Examples of the synchronization device 10 include industrial machines, hut the embodiment is not limited to this. Although FIG. 1 illustrates one synchronization device 10 as an example, the actual synchronization system includes one or more synchronization devices connected to the network 2. The synchronization devices use the reference time measured by the server 20 to synchronize their respective internal time with the reference time.

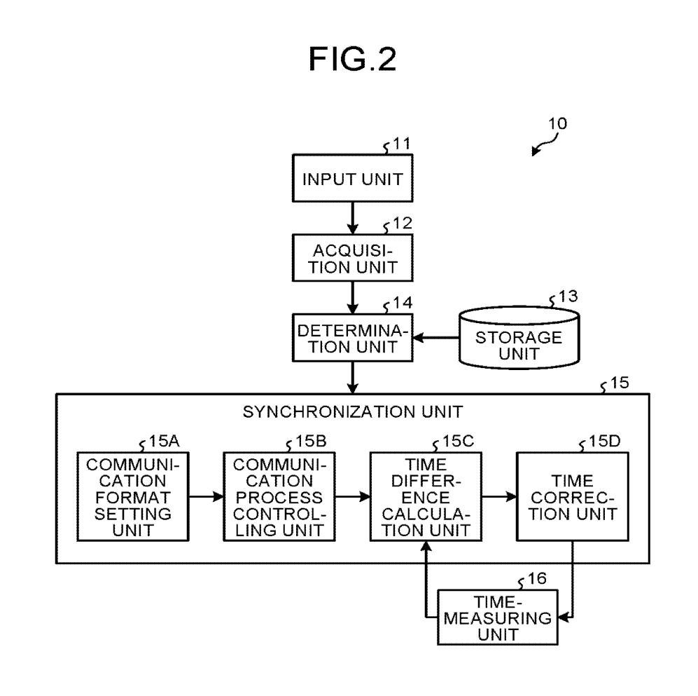

FIG. 2 is a diagram illustrating an example of a configuration of the synchronization device 10 according to the first embodiment. As illustrated in FIG. 2, the synchronization device 10 includes an input unit 11, an acquisition unit 12, a storage unit 13, a determination unit 14, a synchronization unit 15, and a time-measuring unit 16. The synchronization unit 15 includes a communication format setting unit 15A, a communication process controlling unit 155, a time difference calculation unit 155, and a time correction unit 15D.

The input unit 11 can be implemented by input devices such as a mouse and a keyboard. The acquisition unit 12, the determination unit 14, the synchronization unit 15 (the communication format setting unit 15A, the communication process controlling unit 15E, the time difference calculation unit 15C, and the time correction unit 15D), and the time-measuring unit 16 may be implemented by causing a processor, such as a central processing unit (CPU), to execute a computer program, that is, implemented by software, may be implemented by hardware such as an integrated circuit (IC), or may be implemented by both software and hardware. The storage unit 13 can be implemented by a storage device, such as a hard disk drive (HDD), a solid state drive (SSD), a memory card, an optical disc, a random access memory (RAM), and a read only memory (ROM), that can store data therein magnetically, optically, or electrically.

The input unit 11 inputs condition values relating to one or more conditions (hereinafter referred to as “one or more condition values”) by operation from a user. The one or more condition values are used to determine at least one of a certain communication mode and a certain synchronization mode. The certain communication mode is a mode for communicating with the server 20 used in performing time synchronization for synchronizing time between the synchronization device 10 and the server 20. The certain synchronization mode is a mode for synchronizing the time of the synchronization device 10 with the reference time measured by the server 20 used in the time synchronization.

In the first embodiment, the certain communication mode includes a certain communication format setting mode for setting a format of communication subject information, and a certain communication process controlling mode for setting the order and the interval in which and at which the communication subject information is exchanged. Although, in the first embodiment, the certain communication mode includes the certain communication format setting mode and the certain communication process controlling mode, the embodiment is not limited to this. The certain communication mode may include no subdivided modes, include the subdivided modes as described above, or include subdivided modes in other forms that are different from the modes described above.

In the same manner, in the first embodiment, the certain synchronization mode includes a certain calculation mode for calculating a difference in time between the synchronization device 10 and the server 20, and a certain correction mode for correcting the time of the synchronization device 10 to the time measured by the server 20. Although, in the first embodiment, the certain synchronization mode includes the certain calculation mode and the certain correction mode, the embodiment is not limited to this. The certain synchronization mode may include no subdivided modes, include the subdivided modes as described above, or include subdivided modes in other forms that are different from the modes described above.

In the first embodiment, the one or more condition values may be any condition values used to determine at least one of the certain communication format setting mode, the certain communication process controlling mode, the certain calculation mode, and the certain correction mode. Although, in the following description, the one or more condition values are used to determine the certain communication setting mode, the certain communication process controlling mode, the certain calculation mode, and the certain correction mode, the embodiment is not limited to this. In the following description, the certain communication format setting mode, the certain communication process controlling mode, the certain calculation mode, and the certain correction mode may be simply referred to as certain modes when these modes need not be distinguished from each other.

In the first embodiment, the one or more conditions are at least one of time synchronization accuracy, the number of terminals that can synchronize with the server 20 the total number of synchronization devices that synchronize their internal time with the reference time measured by the server 20, not illustrated in FIG. 1), propagation delay time between the synchronization device 10 and the server 20, communication traffic volume between the synchronization device 10 and the server 20, computational capacity of the synchronization device 10, memory capacity of the synchronization device 10, time limit from the start to the end of time synchronization, and presence or absence of continuity between time before synchronization and time after synchronization. However, the embodiment is not limited to this.

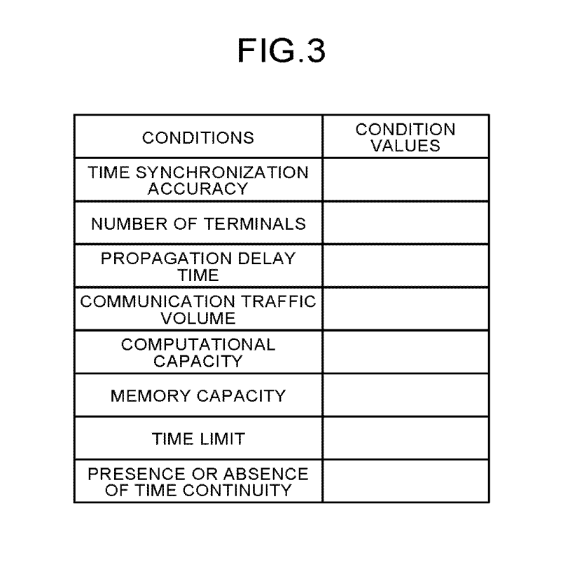

FIG. 3 is a diagram illustrating an example of the one or more condition values input from the input unit 11 according to the first embodiment. In the actual input operation, as illustrated in FIG. 3, the one or more condition values are input with being associated with the respective conditions. In the example of FIG. 3, the one or more condition values are associated with the time synchronization accuracy, the number of terminals that can synchronize with the server 20, the propagation delay time between the synchronization device 10 and the server 20, the communication traffic volume between the synchronization device 10 and the server 20, the computational capacity of the synchronization device 10, the memory capacity of the synchronization device 10, the time limit from the start to the end of time synchronization, and presence or absence of continuity between time before synchronization and time after synchronization. In the example of FIG. 3, the specific values of the one or more condition values are not illustrated.

The acquisition unit 12 acquires the one or more condition values input from the input unit 11.

The storage unit 13 stores therein a determination table based on possible values of the one or more condition values and based on at least a plurality of communication modes or a plurality of synchronization modes. In the first embodiment, the determination table is based on the possible values of the one or more condition values and based on at least a plurality of communication format setting modes, a plurality of communication process controlling modes, a plurality of calculation modes, or a plurality of correction modes.

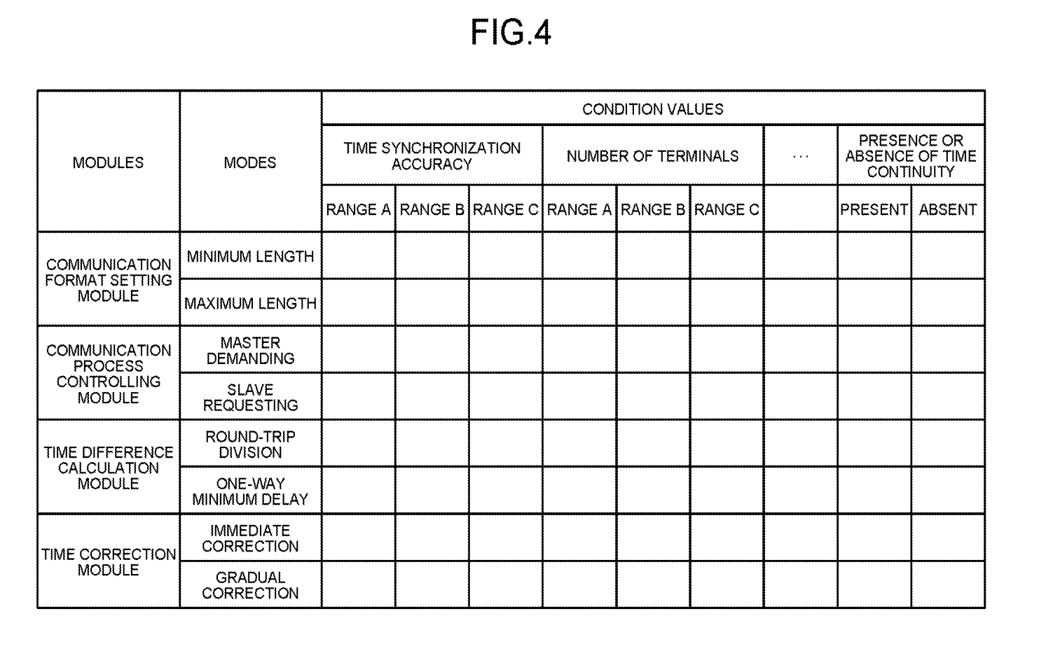

FIG. 4 is a diagram illustrating an example of the determination table according to the first embodiment. In the example of FIG. 4, the determination table is a matrix illustrating the relation between possible condition values of the conditions and the modes. The modes are associated with corresponding modules that can execute these modes.

The condition values are values for the time synchronization accuracy, the number of terminals that can synchronize with the server 20, the propagation delay time between the synchronization device 10 and the server 20, the communication traffic volume between the synchronization device 10 and the server 20, the computational capacity of the synchronization device 10, the memory capacity of the synchronization device 10, the time limit from the start to the end of the time synchronization, and presence or absence of continuity between time before synchronization and time after synchronization.

The possible condition values are divided into three ranges, that is, a range from the possible minimum value to the possible maximum value of each condition values is divided into a range A, a range B, and a range C, except for the presence or absence of continuity between time before synchronization and time after synchronization. As for time synchronization accuracy for example, condition values smaller than X microseconds fall within the range A, condition values equal to or larger than X microseconds and smaller than Y microseconds fall within the range B, and condition values equal to or larger than Y microseconds fall within the range C. However, the method of dividing the condition values is not limited to this. As for presence or absence of continuity between time before synchronization and time after synchronization, the possible value of the condition is either present or absent.

A communication format setting module implements the communication format setting unit 15A, and is associated with a minimum length mode and a maximum length mode, which are the communication format setting modes. The minimum length mode is a mode in which minimum information necessary for time synchronization is written in a communication frame, and the maximum length mode is a mode in which blank information is inserted in the communication frame to increase the frame size.

A communication process controlling module implements the communication process controlling unit 15B, and is associated with a master demanding mode and a slave requesting mode, which are the communication process controlling modes. The master demanding mode a mode in which a master (server 20) polls slaves (synchronization devices 10) cause the slaves one by one to perform time synchronization with the master. The slave requesting mode in a mode in which the slaves (synchronization devices 10) perform time synchronization with the master (server 20) at their respective timings.

A time difference calculation module implements the time difference calculation unit 150 and is associated with a round-trip division mode and a one-way minimum delay mode, which are the calculation modes. The round-trip division mode is a mode for calculating a time difference (communication delay) from a plurality of round-trip times. The one-way minimum delay mode is a mode for calculating, from the minimum round-trip time, a time difference (communication delay) occurring in a way from the master (server 20) to the slave (synchronization device 10).

A time correction module implements the time correction unit 150 and is associated with an immediate correction mode and a gradual correction mode, which are the correction modes. The immediate correction mode is for correcting the time difference to zero at one time, and the gradual correction mode is for correcting the time difference gradually over a plurality of times.

In the example of FIG. 4, individual values in the cells of the matrix are not illustrated. In the actual matrix, however, the cells contain evaluation values (evaluation scores) of the modes with respect to the respective condition values. For example, a cell specified by a condition value in the range A of time synchronization accuracy and by a mode of the master demanding mode contains, for example, Z points. Evaluation values of the modes with respect to the respective condition values may be determined in advance by a user on the basis of a certain scoring rule. The scoring rule may be any rule such as a rule determined by the user by evaluating the modes in advance.

The plurality of modes associated with the module have comparative merits and demerits depending on the condition values. For example, when the master demanding mode and the slave requesting mode are compared, which are the communication process controlling modes, the master demanding mode is less likely to cause the competition of timing of the time synchronization process even if a plurality of slaves (synchronization devices) are present. Such less competition of timing can avoid fluctuations in time differences (communication delay). More fluctuations in time differences (communication delay) can cause more errors in estimating correct reference time (reference time obtained by adding communication time between the synchronization device 10 and the server 20 to the reference time measured by the server 20) at the synchronization device 10. Thus, the master demanding mode has an advantage (has a higher evaluation value) over the slave requesting mode with respect to time synchronization accuracy.

When the minimum length mode and the maximum length mode are compared, which are the communication format setting modes, the minimum length mode can perform communication in a smaller frame size. Thus, the minimum length mode has an advantage (has a higher evaluation value) over the maximum length mode with respect to the communication traffic volume. In the same manner, when the minimum length mode and the maximum length mode are compared, the maximum length mode performs communication in a larger frame size, and causes fewer fluctuations in communication delay. Thus, the maximum length mode has an advantage (has a higher evaluation value) over the minimum length mode with respect to the time synchronization accuracy.

When the round-trip division mode and the one-way minimum delay mode are compared, which are the calculation modes, the one-way minimum delay mode has an advantage (has a higher evaluation value) over the round-trip division mode with respect to the time synchronization accuracy. This is because minimum round-trip time means fewer competitions with other frames in both outward trip and return trip, and thus there is lower possibility of fluctuations in communication delay. The one-way minimum delay mode, however, needs to perform time synchronization a plurality of times, and needs more time than the round-trip division mode. Thus, the round-trip division mode has an advantage (has a higher evaluation value) over the one-way minimum delay mode with respect to the time limit from the start to the end of the time synchronization.

When the immediate correction mode and the gradual correction mode are compared, which are the correction modes, the gradual correction mode requires more time than the immediate correction mode. Thus, the immediate correction mode has an advantage (has a higher evaluation value) over the gradual correction mode with respect to the time limit from the start to the end of the time synchronization. However, the gradual correction mode can ensure continuity between the time before synchronization and the time after the synchronization. Thus, the gradual correction mode has an advantage (has a higher evaluation value) over the immediate correction mode with respect to the presence or absence of continuity between time before synchronization and time after synchronization.

The determination unit 14 determines at least one of a certain communication mode out of a plurality of communication modes and a certain synchronization mode out of a plurality of synchronization modes by using the one or more condition values acquired by the acquisition unit 12. Specifically, the determination unit 14 determines at least one of a certain communication mode out of a plurality of communication modes and a certain synchronization mode out of a plurality of synchronization modes by using the one or more condition values acquired by the acquisition unit 12 and the determination table stored in the storage unit 13.

In the first embodiment, the determination unit 14 determines at least one of a certain communication format setting mode out of a plurality of communication format setting modes, a certain communication process controlling mode out of a plurality of communication process controlling modes, a certain calculation mode out of a plurality of calculation modes, and a certain correction mode out of a plurality of correction modes by using the one or more condition values acquired by the acquisition unit 12. Specifically, the determination unit 14 determines at least one of a certain communication format setting mode out of a plurality of communication format setting modes, a certain communication process controlling mode out of a plurality of communication process controlling modes, a certain calculation mode out of a plurality of calculation modes, and a certain correction mode out of a plurality of correction modes by using the one or more condition values acquired by the acquisition unit 12 and the determination table stored in the storage unit 13.

For example, the determination unit 14 uses the one or more condition values acquired by the acquisition unit 12 to specify, for each mode defined in the determination table, evaluation values with respect to the respective condition values, and adds the specified evaluation values to obtain the sum of evaluation values for each mode. The determination unit 14 determines, as the certain mode, a mode having the highest sum of evaluation values out of the plurality of modes associated with each module defined in the determination table.

Refer to the example of FIG. 4. Regarding the communication format setting module, a mode having the larger sum of evaluation values out of the minimum length mode and the maximum length mode, which are the communication format setting modes, is determined to be the certain communication format setting mode. Regarding the communication process controlling module, a mode having the larger sum of evaluation values out of the master demanding mode and the slave requesting mode, which are the communication process controlling modes, is determined to be the certain communication process controlling mode. Regarding the time difference calculation module, a mode having the larger sum of evaluation values out of the round-trip division mode and the one-way minimum delay mode, which are the calculation modes, is determined to be the certain calculation mode. Regarding the time correction module, a mode having the larger sum of evaluation values out of the immediate correction mode and the gradual correction mode, which are the correction modes, is determined to be the certain correction mode.

The synchronization unit 15 performs time synchronization with the server 20 by using the certain communication mode and the certain synchronization mode determined by the determination unit 14. In the first embodiment, the synchronization unit 15 performs the time synchronization with the server 20 by using the certain communication format setting mode, the certain communication process controlling mode, the certain calculation mode, and the certain correction mode that are determined by the determination unit 14.

The determination unit 14 determines at least one of the certain communication format setting mode, the certain communication process controlling mode, the certain calculation mode, and the certain correction mode. If there is a mode that is not determined by the determination unit 14, a default mode is set to the mode. In this case, the synchronization unit 15 may perform the time synchronization with the server 20 by using the certain modes determined by the determination unit 14 and one or more default modes.

Assume that, for example, the determination unit 14 determines the certain communication format setting mode and the certain correction mode, but does not determine the certain communication process controlling mode or the certain calculation mode. In this case, the synchronization unit 15 may perform the time synchronization with the server 20 by using the certain communication format setting mode and the certain correction mode determined by the determination unit 14 and the default communication process controlling mode and the default calculation mode.

Specifically, the time synchronization with server 20 is performed as follows. First, the communication format setting unit 15A sets a communication format for communicating with the server 20 in the certain communication format setting mode determined by the determination unit 14. The communication process controlling unit 15B then controls, in the certain communication process controlling mode determined by the determination unit 14, communication between the synchronization device 10 and the server 20 in the communication format set by the communication format setting unit 15A, and acquires the reference time measured by the server 20. Subsequently, the time difference calculation unit 15C calculates a difference between the reference time measured by the server 20 and the time of the synchronization device 10 measured by the time-measuring unit 16 in the certain calculation mode determined by the determination unit 14. The time correction unit 15D then corrects, in the certain correction mode determined by the determination unit 14, time of the synchronization device 10 measured by the time-measuring unit 16 by using the time difference calculated by the time difference calculation unit 15C.

The time-measuring unit 16 measures time of the synchronization device 10.

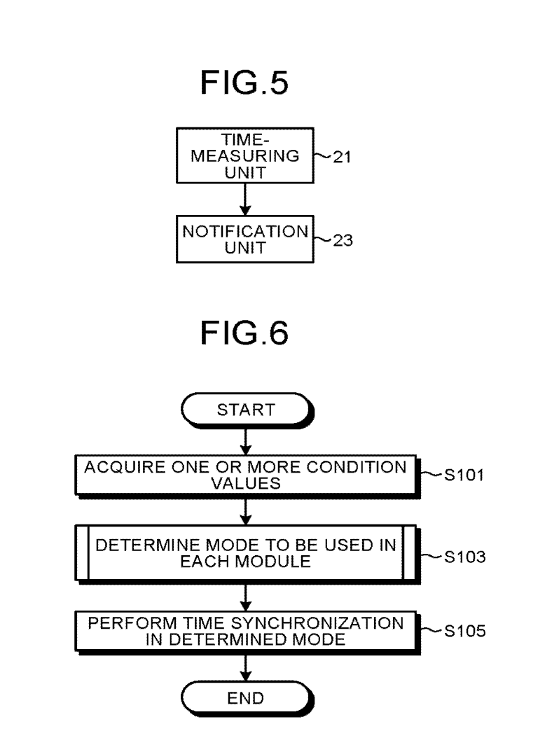

FIG. 5 is a diagram illustrating an example of a configuration of the server 20 according to the first embodiment. As illustrated in FIG. 5, the server 20 includes a time-measuring unit 21 and a notification unit 23.

The time-measuring unit 16 and the notification unit 23 may be implemented by causing a processor, such as a CPU, to execute a computer program, that is, implemented by software, may be implemented by hardware such as an IC, or may be implemented by both software and hardware.

The time-measuring unit 21 measures the reference time.

The notification unit 23 notifies the synchronization device 10 of the reference time measured by the time-measuring unit 21 in the certain communication mode used by the synchronization device 10. In the first embodiment, the notification unit 23 notifies the synchronization device 10 of the reference time measured by the time-measuring unit 21, in a certain communication format setting mode and a certain communication process controlling mode used by the synchronization device 10.

Regarding the certain communication format setting mode and the certain communication process controlling mode used by the synchronization device 10; the server 20 may acquire information on the certain communication format setting mode and the certain communication process controlling mode from the synchronization device 10 as a preprocessing of the time synchronization, or may determine the certain communication format setting mode and the certain communication process controlling mode by using the determination method described above for the synchronization device 10. In the latter case, for example, the server 20 stores therein the same determination table as that stored in the synchronization device 10 (storage unit 13) in advance and acquires the one or more condition values from the synchronization device 10.

FIG. 6 is a flowchart illustrating an example of the process procedure performed by the synchronization device 10 according to the first embodiment.

First, the acquisition unit 12 acquires one or more condition values input from the input unit 11 (Step S101).

The determination unit 14 then determines certain modes (a certain communication format setting mode used in the communication format setting unit 15A, a certain communication process controlling mode used in the communication process controlling unit 15B, a certain calculation mode used in the time difference calculation unit 15C, and the certain correction mode used in the time correction unit 15D) to be used in the respective modules by using the one or more condition values acquired by the acquisition unit 12 and the determination table stored in the storage unit 13 (Step S103).

Subsequently, the synchronization unit 15 (the communication format setting unit 15, the communication process controlling unit 15E, the time difference calculation unit 15C, and the time correction unit 15D) performs time synchronization with the server 20 by employing the certain communication format setting mode, the certain communication process controlling mode, the certain calculation mode, and the certain correction mode determined by the determination unit 14 (Step S105).

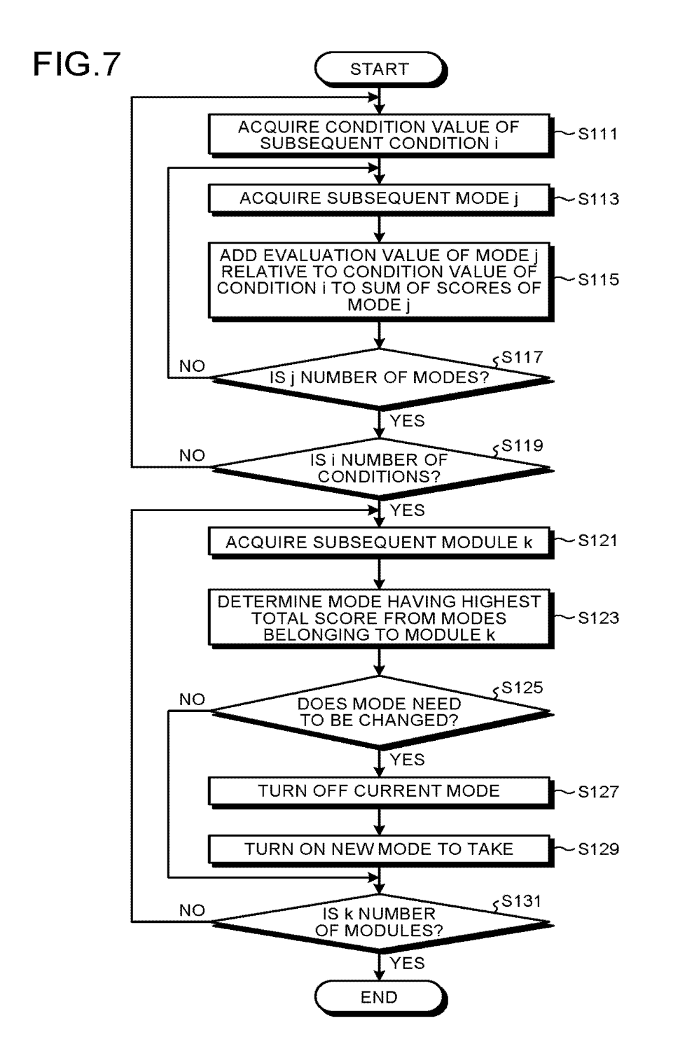

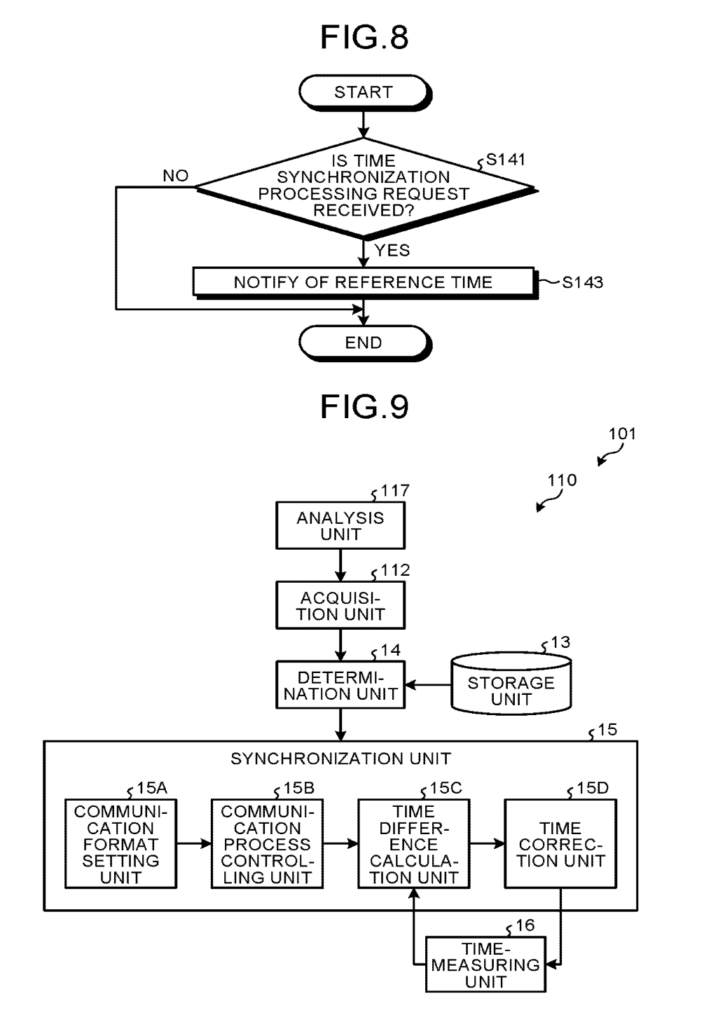

FIG. 7 is a flowchart illustrating an example of the process procedure performed at Step S103 in FIG. 6.

First, the determination unit 14 acquires a condition value of a subsequent (unprocessed) condition i from the one or more condition values acquired by the acquisition unit 12 (Step S111). The initial value of i is one. The condition values may be acquired in any order.

The determination unit 14 then acquires a subsequent (unprocessed) mode j from a plurality of modes defined in the determination table stored in the storage unit 13 (Step S113). The initial value of j is one. The modes may be acquired in any order.

The determination unit 14 then acquires an evaluation value of the mode j with respect to the condition value of the condition i from the evaluation values defined in the determination table stored in the storage unit 13, and adds the evaluation value to the sum of evaluation values of the mode j (Step S115). The initial value of the sum of evaluation values of the mode j is zero.

The determination unit 14 then determines whether the value of j is equal to the number of modes (Step 117). If the value of j is not equal to the number of modes (No at Step S117), the process returns to Step S113. The value of j is incremented at this time. If the value of j is equal to the number of modes (Yes at Step S117), the process proceeds to Step S119.

The determination unit 14 then determines whether the value of i is equal to the number of conditions (Step S119). If the value of i is not equal to the number of conditions (No at Step S119), the process returns to S111. The value of i is incremented at this time. If the value of i is equal to the number of conditions (Yes at Step S119), the process proceeds to Step S121.

The determination unit 14 then acquires a subsequent (unprocessed) module k from a plurality of modules defined in the determination table stored in the storage unit 13 (Step S121). The initial value of k is one. The modules may be acquired in any order.

The determination unit 14 then determines a mode, out of the modes belonging to (associated with) the module k, having the highest sum of evaluation values as the certain mode to be used by the module k (Step S123).

If it is necessary to change the certain mode (Yes at Step S125), the synchronization unit 15 (specifically, a unit, out of the communication format setting unit 15A, the communication process controlling unit 15B, the time difference calculation unit 15C, and the time correction unit 150, implemented by the module k) turns off the current certain mode (Step S127), and turns on the mode to be used by the module k (Step S129), thereby changing the certain mode to a mode to be used by the module k.

If no at Step S125, the processes at Steps S127 and S129 are skipped.

The synchronization unit 15 then determines whether the value of k is equal to the number of modules (Step S131). If the value of k is not equal to the number of modules (No at Step S131), the process returns to Step S121. The value of k is incremented at this time. If the value of k is equal to the number of modules (Yes at Step S131), the process is ended.

FIG. B is a flowchart illustrating an example of the process procedure performed by the server 20 according to the first embodiment.

If the notification unit receives a time synchronization request (request for starting time synchronization) from the synchronization device 10 (Yes at Step S141), the notification unit 23 notifies the synchronization device 10 of the reference time measured by the time-measuring unit 21, in the certain communication format setting mode and the certain communication process controlling mode used in the synchronization device 10 (Step S143).

If no at Step S141, the process at Step S143 is skipped.

According to the first embodiment, a plurality of certain modes to be used in the time synchronization are determined on the basis of the one or more condition values input by a user. The user inputs the condition values taking the usage of the time after synchronization into consideration. Thus, time synchronization is performed suitably for the usage and can be used for various purposes.

### Second Embodiment

In a second embodiment, an example of automatic input of the one or more condition values will be described. The following mainly describes the differences between the first and the second embodiments. The same names and reference signs as those in the first embodiment are given to the constituent elements having the same functions as those in the first embodiment, and the description thereof is omitted.

FIG. 9 is a diagram illustrating an example of a configuration of a synchronization device 110 in a synchronization system 101 according to the second embodiment. As illustrated in FIG. 9, the synchronization device 110 in the synchronization system 101 in the second embodiment differs from the synchronization device 10 in the first embodiment in that it includes an analysis unit 117 instead of the input unit 11, and includes a different acquisition unit 112.

The analysis unit 117 analyses communication performed via the network 2 to extract condition values of the one or more conditions.

When, for example, there are a plurality of synchronization devices that perform time synchronization with the server 20 (synchronization devices 110 are not illustrated), each synchronization device sends, to the server 20 and also to the other synchronization devices, a synchronization participation notification that indicates its intention to perform time synchronization with the server 20.

Thus, regarding the number of terminals that can synchronize with the server 20, the analysis unit 117 may analyze the synchronization participation notifications sent from one or more synchronization devises that can synchronize with the server 20 and extract the total number of the synchronization participation notifications as a condition value of the number of terminals.

Regarding the propagation delay time between the synchronization device 110 and the server 20, the analysis unit 117 may analyze the communication round-trip time between them and extract a condition value of the propagation delay time. For example, the analysis unit. 117 may extract half the round-trip time as a condition value the propagation delay time.

Regarding the communication traffic volume between the synchronization device 110 and the server 20, the analysis unit 117 may analyze the communication between the synchronization device 110 and a relaying device (not illustrated) that relays communication between the synchronization device 10 and the server 20 and extract a condition value of the communication traffic volume. Examples of the relaying device include a router and a switch. For example, the analysis unit. 117 may extract the communication traffic volume notified by the relaying device as a condition value of the communication traffic volume.

The acquisition unit 112 acquires the one or more condition values extracted by the analysis unit 117.

According to the second embodiment, one or more condition values are input by analyzing the communication performed via the network 2. This configuration allows automatic input of the one or more condition values. In particular, inputting one or more condition values at regular intervals by analyzing the communication performed via the network 2 can optimize the time synchronization on a real-time basis in accordance with the usage even when changes occur in the environment (the number of terminals, the propagation delay time, or the communication traffic volume, for example).

The second embodiment may be combined with the first embodiment. For example, the synchronization system 101 may use the method of the first embodiment at the start of its operation, and may use the method of the second embodiment after the start of its operation. This configuration can perform time synchronization suitable for the usage, and thus the time after the synchronization can be used for various purposes. When changes occur in the environment (the number of terminals, the propagation delay time, or the communication traffic volume, for example), the time synchronization can be optimized on a real-time basis in accordance with the usage.

The second embodiment does not necessarily use the conditions described in the first embodiment and may use the conditions having condition values that can be acquired by analyzing communication.

### Third Embodiment

In a third embodiment, an example of inputting one or more condition values from a management device will be described. The following mainly describes the differences between the first and the third embodiments. The same ram and reference signs as those in the first embodiment are given to the constituent elements having the same functions as those in the first embodiment, and the description thereof is omitted.

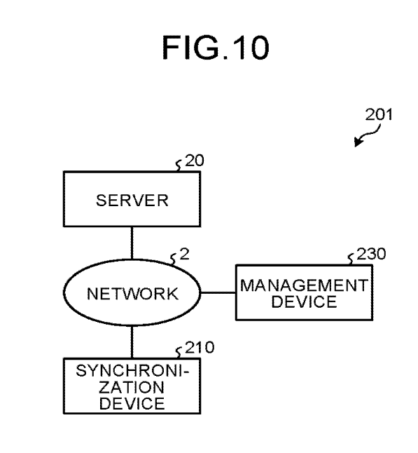

FIG. 10 is a diagram illustrating an example of a configuration of a synchronization system 201 according to the third embodiment. As illustrated in FIG. 10, the synchronization system 201 in the third embodiment differs from the synchronization system 1 in the first embodiment in that it includes a management device 230 (an example of an external input device), and includes a different synchronization device 210.

The management device 230 receives one or more condition values from operation of the user, and notifies the synchronization device 10 and other synchronization devices (not illustrated) than the synchronization device 210 that perform time synchronization with the server 20 of the one or more condition values.

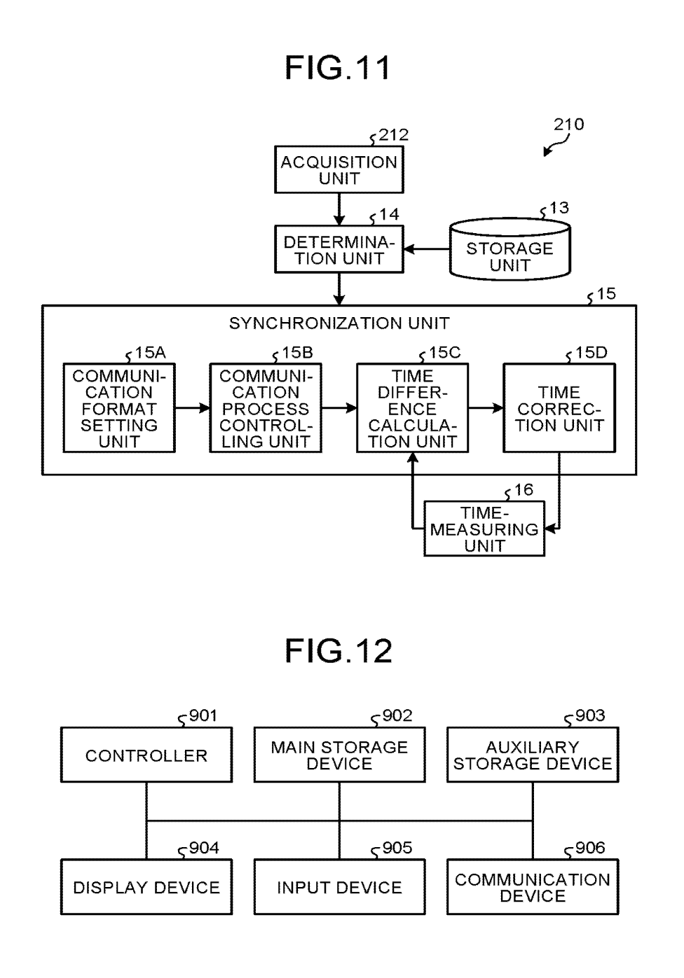

FIG. 11 is a diagram illustrating an example of a configuration of the synchronization device 210 according to the third embodiment. As illustrated in FIG. 11, the synchronization device 10 in the third embodiment differs from the synchronization device 10 in the first embodiment in that it does not include the input unit 11 and includes a different acquisition unit 212.

The acquisition unit 212 acquires one or more condition values from the management device 230.

The configuration according to the third embodiment enables the synchronization devices to use the same one or more condition values.

The management device 230 may include the storage unit 13 and the determination unit 14, and notify the synchronization devices of the certain communication format setting mode, the certain communication process controlling mode, the certain calculation mode, and the certain correction mode determined by the determination unit 14, instead of notifying the synchronization devices of the one or more condition values. This configuration enables the synchronization devices to perform time synchronization in the same modes.

Hardware Configuration

FIG. 12 is a diagram illustrating an example of a hardware configuration of the synchronization devices according to the embodiments above. As illustrated in FIG. 12, the synchronization devices according to the embodiments above include a controller 901 such as a CPU, a main storage device 902 such as a ROM and a RAM, an auxiliary storage device 903 such as an HDD or an SSD, a display device 904 such as a display, an input device 905 such as a keyboard and a mouse, and a communication device 906 such as a communication interface. The synchronization devices are configured by general-purpose computers.

The computer program executed in the synchronization devices according to the embodiments above is recorded and provided in a computer-readable recording medium such as a compact disc read only memory (CD-ROM), a compact disc recordable (CD-R), a memory card, a digital versatile disc (DVD), and a flexible disk (FD) as an installable and/or executable file.

The computer program executed in the synchronization devices according to the embodiments above may be stored in a computer connected to a network such as the Internet and provided by being downloaded via the network. Furthermore, the computer program executed in the synchronization devices according to the embodiments above may be provided or distributed via a network such as the Internet. The computer program executed in the synchronization devices according to the embodiments above may be embedded and provided in a ROM, for example.

The computer program executed in the synchronization devices according to the embodiments above is configured by modules that implement the units described above on a computer. As an actual hardware configuration, the CPU reads the computer program from, for example, the ROM and the HDD to load it on the RAM and executes it, and the units are implemented on the computer.

When at least a part of the units is implemented by hardware such as an integrated circuit (IC), the synchronization devices according to the embodiments above may further include such an IC, for example.

The processes in the flowchart according to the first embodiment may be performed in a different order, a plurality of the processes may be performed at the same time, or the processes may be performed in a different order each time the time synchronization is performed, without departing from the nature of the embodiments.

As described above, according to the embodiments, time after the synchronization can be used for various purposes.

While certain embodiments have been described, these embodiments have been presented by way of example only, and are not intended to limit, the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A synchronization control device connectable to a server via a network, the device comprising:
an acquisition unit configured to acquire one or more condition values relating to one or more conditions for determining at least one of a certain communication mode and a certain synchronization mode, the certain communication mode being a mode for communicating with the server and being used in time synchronization for synchronizing time between the synchronization control device and the server, the certain synchronization mode being a mode for synchronizing time of the synchronization control device with reference time measured by the server and being used in the time synchronization; and
a determination unit configured to determine, by using the one or more condition values, at least one of the certain communication mode out of a plurality of communication modes and the certain synchronization mode out of a plurality of synchronization modes.

2. The device according to claim 1, wherein
the certain communication mode includes a certain communication format setting mode for setting a format of communication subject information and a certain communication process controlling mode for setting an order and an interval in which and at which the communication subject information is exchanged,
the certain synchronization mode includes a certain calculation mode for calculating a difference in time between the synchronization control device and the server, and a certain correction mode for correcting the time of the synchronization control device to the time measured by the server,
the one or more condition values are used to determine at least one of the certain communication format setting mode, the certain communication process controlling mode, the certain calculation mode, and the certain correction mode, and
the determination unit determines, by using the one or more condition values, at least one of the certain communication format setting mode out of a plurality of communication format setting modes, the certain communication process controlling mode out of a plurality of communication process controlling modes, the certain calculation mode out of a plurality of calculation modes, and the certain correction mode out of a plurality of correction modes.

3. The device according to claim 1, wherein the determination unit determines at least one of the certain communication mode out of the communication modes and the certain synchronization mode out of the synchronization modes by using a determination table and the one or more condition values, the determination table being based on possible values of the one or more condition values and based on at least one of the communication modes and the synchronization modes.

4. The device according to claim 1, wherein the one or more conditions are at least one of
time synchronization accuracy;
number of terminals capable of synchronizing with the server;
propagation delay time between the synchronization control device and the server;
communication traffic volume between the synchronization control device and the server;
computational capacity of the synchronization control device;
memory capacity of the synchronization control device;
time limit from start to end of the time synchronization; and
presence or absence of continuity between time synchronization and time after the synchronization.

5. The device according to claim 1, further comprising:
a synchronization unit configured to perform the time synchronization by using the determined certain communication mode and the determined certain synchronization mode.

6. The device according to claim 1, wherein the acquisition unit acquires the one or more condition values from an input unit.

7. The device according to claim 1, further comprising:
an analysis unit configured to analyze communication performed via the network to extract the one or more condition values, wherein
the acquisition unit acquires the one or more condition values from the analysis unit.

8. The device according to claim 7, wherein
the one or more condition values include at least a value indicating number of terminals capable of synchronizing with the server, and
the analysis unit analyzes a synchronization participation notification sent from one or more terminals capable of synchronizing with the server to extract a condition value of the number of the terminals.

9. The device according to claim 7, wherein
the one or more condition values include at least a value indicating propagation delay time between the synchronization control device and the server, and
the analysis unit analyzes communication round-trip time between the synchronization control device and the server to extract a condition value of the propagation delay time.

10. The device according to claim 7, wherein
the one or more condition values include at least a value indicating communication traffic volume between the synchronization control device and the server, and
the analysis unit analyzes communication between the synchronization control device and a relaying device that relays communication between the synchronization control device and the server to extract a condition value of the communication traffic volume.

11. The device according to claim 1, wherein the acquisition unit acquires the one or more condition values from an external input device connected to the synchronization control device via the network.

12. A synchronization system comprising:
a synchronization control device; and
a server connectable to the synchronization control device via a network, wherein
the synchronization control device includes
an acquisition unit configured to acquire one or more condition values relating to one or more conditions for determining at least one of a certain communication mode and a certain synchronization mode, the certain communication mode being a mode for communicating with the server and being used in time synchronization for synchronizing time between the synchronization control device and the server, the certain synchronization mode being a mode for synchronizing time of the synchronization control device with time measured by the server and being used in the time synchronization,
a determination unit configured to determine, by using the one or more condition values, at least one of the certain communication mode out of a plurality of communication modes and the certain synchronization mode out of a plurality of synchronization modes, and
a synchronization unit configured to perform the time synchronization by using the determined certain communication mode and the determined certain synchronization mode, and
the server includes
a time-measuring unit configured to measure reference time, and
a notification unit configured to notify the synchronization control device of the reference time in the certain communication mode.

13. A synchronization control method performed by a synchronization control device connectable to a server via a network, the method comprising:
acquiring one or more condition values relating to one or more conditions for determining at least one of a certain communication mode and a certain synchronization mode, the certain communication mode being a mode for communicating with the server and being used in time synchronization for synchronizing time between the synchronization control device and the server, the certain synchronization mode being a mode for synchronizing time of the synchronization control device with reference time measured by the server and being used in the time synchronization; and
determining, by using the one or more condition values, at least one of the certain communication mode out of a plurality of communication modes and the certain synchronization mode out of a plurality of synchronization modes.
